(19) United States
(12) Patent Application Publication
(10) Pub. No.: US 2004/0094561 A1
(43) Pub. Date: May 20, 2004

(54) Container lid assembly

(75) Inventors: Alex Degutis, East Chicago, IN (US); Charles Lonnie Horne, Chicago, IL (US); Kathryn R. Sims Johnson, Tinley Park, IL (US); Joshua J. Chesser, Downers Grove, IL (US); Bryan S. Allen, Joliet, IL (US)

Correspondence Address: JENNER & BLOCK, LLC, ONE IBM PLAZA, CHICAGO, IL, 60611, US

(73) Assignee: Salco Products, Inc.

(21) Appl. No.: 10/300,307

(22) Filed: Nov. 20, 2002

(51) Int. Cl. B65F 1/00

(52) U.S. Cl. 220/812; 220/832; 220/833; 220/908

(57) ABSTRACT

A lid for a container. The container comprises a center piece and two identically shaped and sized end pieces separably attached to opposite sides of the center piece.

### BACKGROUND OF THE INVENTION

The present invention relates to a lid assembly for a container. More specifically, it relates to a lid assembly for a waste handling container.

Hazardous waste materials are frequently transported to disposal facilities in very large waste handling containers. Such waste handling containers have an opening in the top of the container for loading of waste materials. To safely close off this large opening, typically a one-piece lid, as shown in U.S. Pat. No. 6,364,153 to Petzitillo, Jr. et al., covers the entire opening and form a tight seal against the container body to prevent the hazardous waste material from escaping during transport. Such prior art one-piece lid and the waste handling container is illustrated in FIG. 1. The prior art waste handling container 10 have a rectangular profile. The top wall 12 defines an opening 14 and includes a movable lid 16 that is sized to cover and sealingly close the opening 14. The lid 16 is rectangularly shaped, and has a support frame 18 and a cover sheet 20. An annular seal receptacle 22 is located on its bottom surface, adjacent to its peripheral edges, and positioned in corresponding relation to the top wall 12 of the container 10. The annular seal receptacle 22 is sized and shaped to house an elastomeric gasket (not shown).

As illustrated in FIG. 3, a pivot socket 24 is provided in the frame 18, and is located on each lateral edge of the lid 16. The pivot socket 24 is sized and shaped to pivotally receive a carriage assembly 26. The carriage assembly 26 has a pivot rod 28, a roller support beam 30 and a plurality of rollers 32 mounted to the roller support beam 30. The pivot rod 28 is inserted into the pivot socket 24 to pivotally connect the lid 16 with the carriage assembly 26. Two guide rails 34 are mounted on the top wall 12 of the container 14 on both sides of the opening 14. The rollers 32 of each carriage assembly 26 cooperate with the guide rails 34 to move the lid 16 laterally across the top wall 12 of the container 10 to exposed the opening 14. A ratchet binder 36 operates to move each guide rail 34 upwardly off the top wall 12. By moving the guide rails 34 upwardly, the lid 16 also moves upwardly allowing the gasket in the seal receptacle 22 to disengage from the top wall 12 of the container 10.

The prior art container 10 has four locking clamps 38 on the container 10. Each clamp 38 includes a lever 40 which allows a rod 42 to be move vertically. A hook (not shown) is secured at the top of the rod 42. The hook of each clamp 38 is adapted to engage and lock with a corresponding ring 44 attached to the lid 16.

To unlock the prior art lid 16, the lever 40 is pivoted to move the rod 42 and its hook to an upwardly disengaged position. The rods and their hooks are then pivoted outwardly to completely clear the rings 44. With all of the rods and hooks outwardly clear of their corresponding rings 44, the ratchet binder 36 raises the lid 16 to disengage the gasket from the top wall 12 of the container 10. Handles 46 on either side of the lid 10 may then be grasped and pulled, which moves lid 16 laterally to that side along guide rails 34. When the lid 16 has moved roughly half its distance to one side, the lid 16 is then pivoted about the pivot rod 28 to expose the opening 14 of the container 10.

While the prior art lid is effective for its intended purpose of sealing the container and still allowing a single to person to easily open the lid, should the lid become damaged, the entire lid must be replaced due the one-piece design of the lid. Therefore, there exists a need for a lid which does not require the entire lid to be replace if only one portion of the lid is damaged.

### BRIEF DESCRIPTION OF THE DRAWINGS

FIG. 1 is a perspective view of a prior art waste handling container;

FIG. 2 is a top view of the prior art lid frame of FIG. 1;

FIG. 3 is a perspective view of the prior art carriage assembly, the prior art guide rail, and a portion of the prior art lid frame of FIG. 1;

FIG. 4 is a perspective view of a waste handling container with a lid in accordance to the present invention;

FIG. 5 is a top view of the lid of FIG. 4, prior to assembling the center piece with the two end pieces;

FIG. 6 is a top view of the lid of FIG. 4, after assembling the lid;

FIG. 7 is a sectional view of the lid of FIG. 6 as taken along line 7-7;

FIG. 8 is a sectional view of the lid of FIG. 6 as taken along line 8-8;

FIG. 9 is a top view of a center frame of the lid of FIG. 6;

FIG. 10 is a front view of the center frame of FIG. 9;

FIG. 11 is a sectional view of the center frame of FIG. 9 as taken along line 11-11;

FIG. 12 is a sectional view of the center frame of FIG. 9 as taken along line 12-12;

FIG. 13 is a sectional view of the center frame of FIG. 9 as taken along line 13-13;

FIG. 14 is a sectional view of the center frame of FIG. 9 as taken along line 14-14;

FIG. 15 is a top view of an end frame of the lid of FIG. 6;

FIG. 16 is a front view of the end frame of FIG. 15;

FIG. 17 is a sectional view of the end frame of FIG. 15 as taken along line 17-17;

FIG. 18 is a sectional view of the end frame of FIG. 15 as taken along line 18-18;

FIG. 19 is a sectional view of the end frame of FIG. 15 as taken along line 19-19;

FIG. 20 is a sectional view of the end frame of FIG. 15 as taken along line 20-20;

FIG. 21 is a sectional view of the end frame of FIG. 15 as taken along line 21-21;

FIG. 22 is a sectional view of the end frame of FIG. 15 as taken along line 22-22;

FIG. 23 is an enlarge front view of the edge beam of the end frame after a cut is made to the edge beam;

FIG. 24 is a side view of the edge beam of FIG. 23; and

FIG. 25 is an enlarge front view of the edge beam of the end frame after the edge beam is bent to camber the end frame.

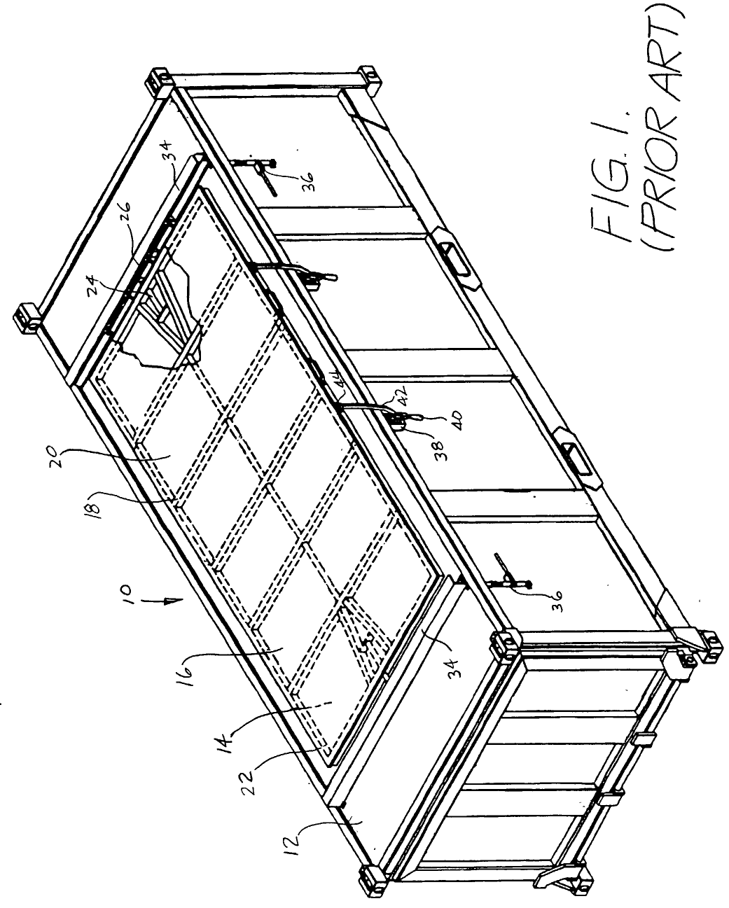

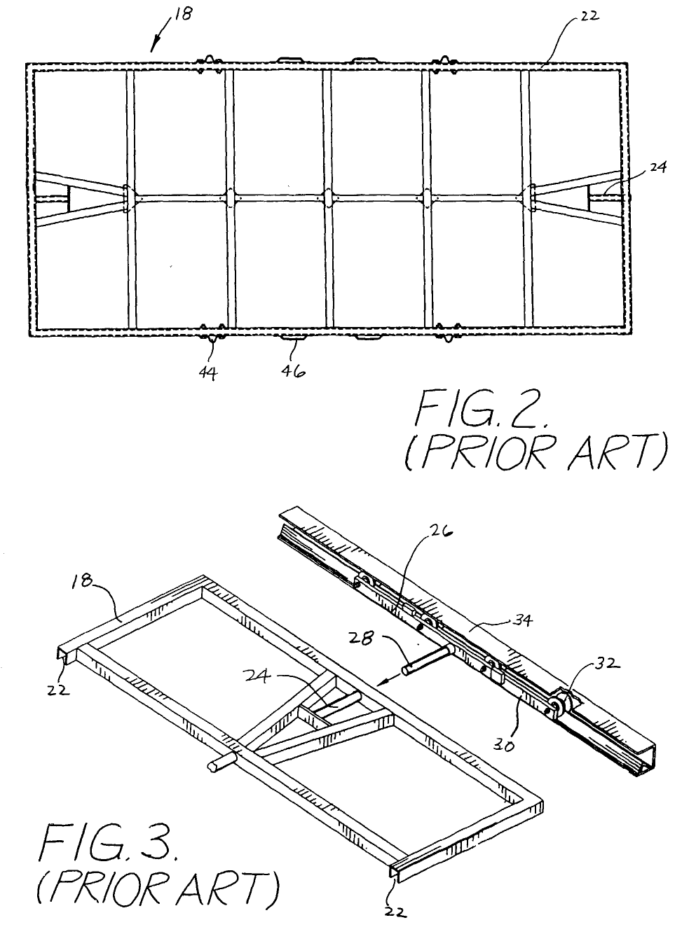

### DETAILED DESCRIPTION OF THE DRAWINGS

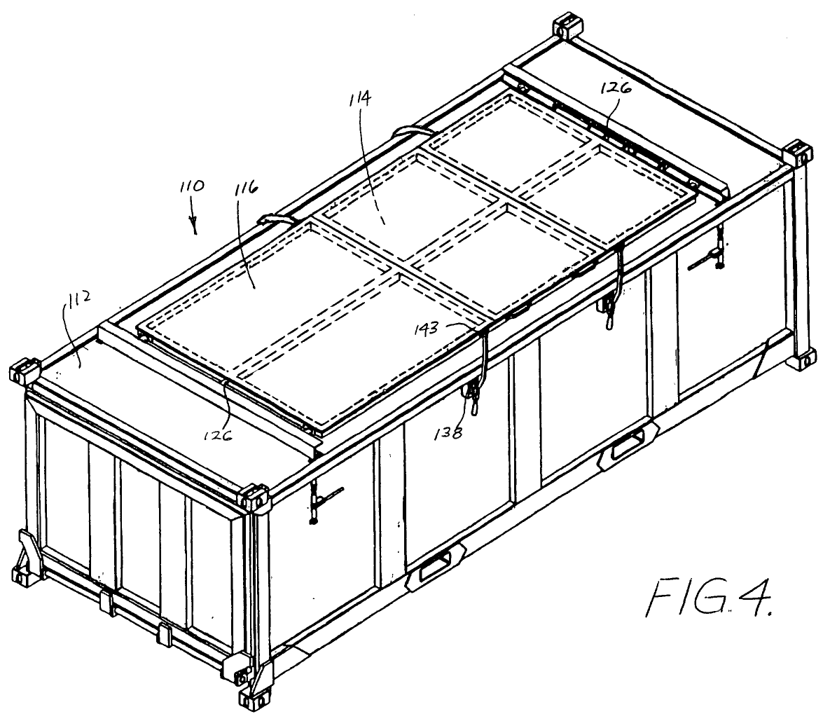

FIG. 4 illustrates a waster handling container 110 with a lid 116 in accordance to the present invention. The lid 116 of the present invention covers the entire opening 114 of the container 110 and forms a tight seal against the top wall 112 of the container 110 to prevent hazardous material from escaping. Similar to the prior art lid 16, the lid 116 is capable of being raised a distance from the top wall 112 of the container 110, slid along the top wall 112 of the container 110 and then pivoted to either side of container 110 to receive waste materials through the opening 114. The mechanisms associated with raising the lid 116 a distance from the top wall 112 of the container 110, sliding the lid 116 along the top wall 112 of container 110 and pivoting the lid 116 to one side is not an object of this invention; therefore, the operations of these mechanisms are not described in detail in the specification of this application; rather, this application incorporates by reference U.S. Pat. No. 6,364,153 which describes the operations of these mechanisms in detail.

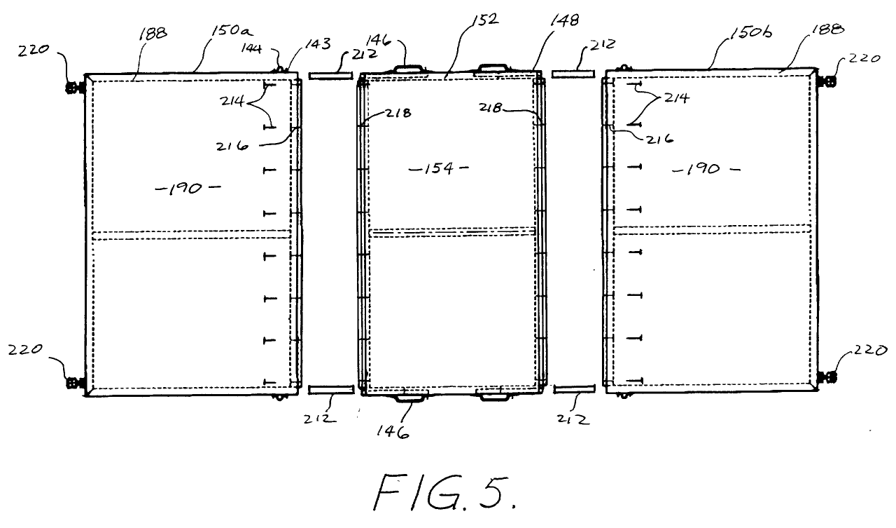

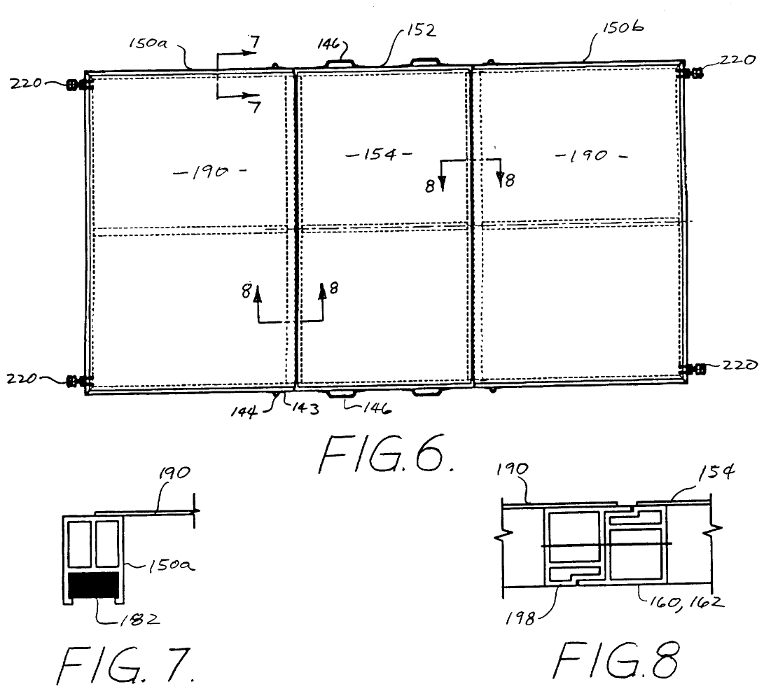

The lid 116 of the present invention is illustrated in FIGS. 5-8. The lid 116 comprises a center piece 148 and two end pieces 150a, 150b separably attached to the sides of the center piece 148. For the purpose of describing the present invention, the term “separably attached” is defined as two pieces being attached to act as a unitary structure, but is able to be easily separated without damaging either piece. The separation can be performed with or without tools. Separably attached is different from permanently attached in which to separate two pieces which were permanently attached, the pieces would need to be cut, broken or some other similar destructive processes. Therefore, two pieces bolted together would be an example of separably attached, whereas, two pieces welded together would be an example of permanently attached.

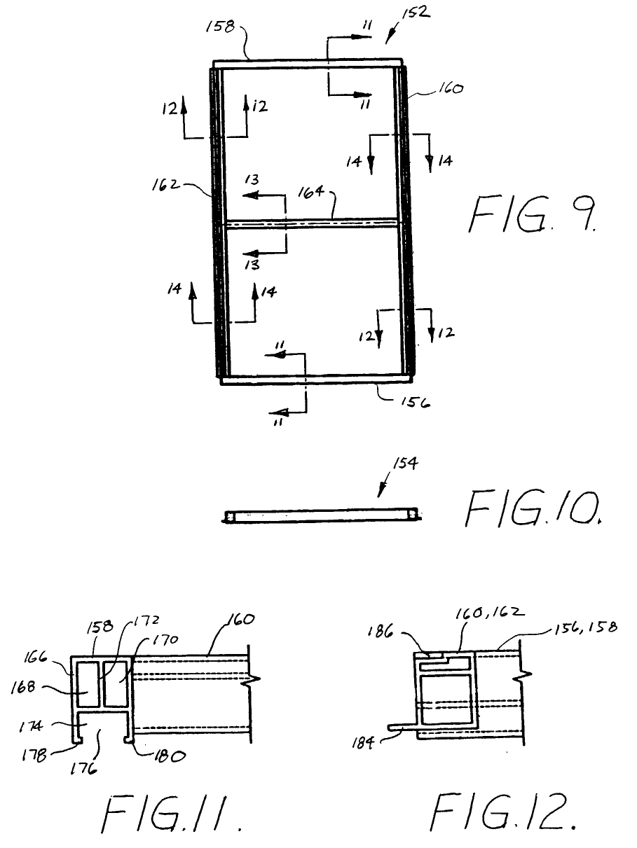

The center piece 148 has a frame 152 and a cover sheet 154 attached to the frame. FIGS. 9-14 illustrate the center frame 152. The center frame 152 is rectangularly shaped with two edge beams 156, 158 forming the front and rear of the center frame 152. The center frame 152 further includes two attachment beams 160, 162 forming the two sides of the center frame and a support beam 164 connected to the attachment beams at the ends of the support beam. The two edge beams 156, 158 are cross-sectionally identical in shape and size. The two attachment beams 160, 162 and the support beam 164 are cross-sectionally identical in shape and size. For the purpose of describing the present invention, the term “cross-sectional identical in shape and size” is defined as the cross-section of at least two components having the same shape and having the same size. It should be noted that components which are cross-sectionally identical in shape and size do not need to have the same length or be oriented in the same direction. The advantage of using components which are cross-sectionally identical in shape and size is that the components can be cut from the same stock. For example, since two edge beams 156, 158 are cross-sectional identical in shape in size, these two beams 156, 158 can be cut from the same stock. Likewise, since the two attachment beams 160, 162 and the support beam 164 are cross-sectionally identical in shape and size, these three beams 160, 162, 164 can be cut from the same stock. This use of beams which are cross-sectionally identical in shape and size greatly reduces the complexity of the stock materials for forming the center piece 148.

FIG. 11 illustrates a cross-sectional view of the edge beam 156, 158. The edge beam 156, 158 has an upper box section 166 and a lower seal receptacle 174. The box section 166 has two cavities 168, 170 extending through the entire length of the edge beam 156, 158 and a rib 172 separating the two cavities. The seal receptacle 174 has a channel 176 defined between two walls. Two hooks 178, 180 extend inwardly from the walls defining the channel 176. The channel 176 and the hooks 178, 180 retain a gasket 182 (illustrated in FIG. 7) to the edge beam 156, 158.

FIGS. 12-14 illustrate cross-sectional views of the attachment beams 160, 162 and the support beam 164. The attachment beams 160, 162 and the support beam 164, each have a tongue 184 and a groove 186. The tongue 184 extends outwardly at one surface. Defined at the opposite surface is the groove 186 having a depth and length approximately equal to the thickness and length of the tongue 184.

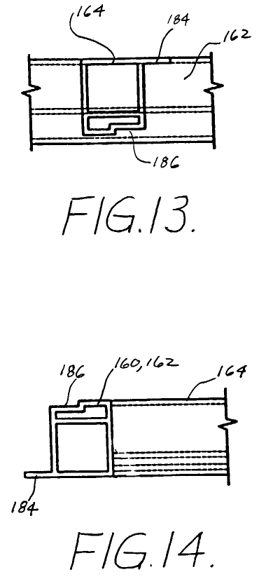

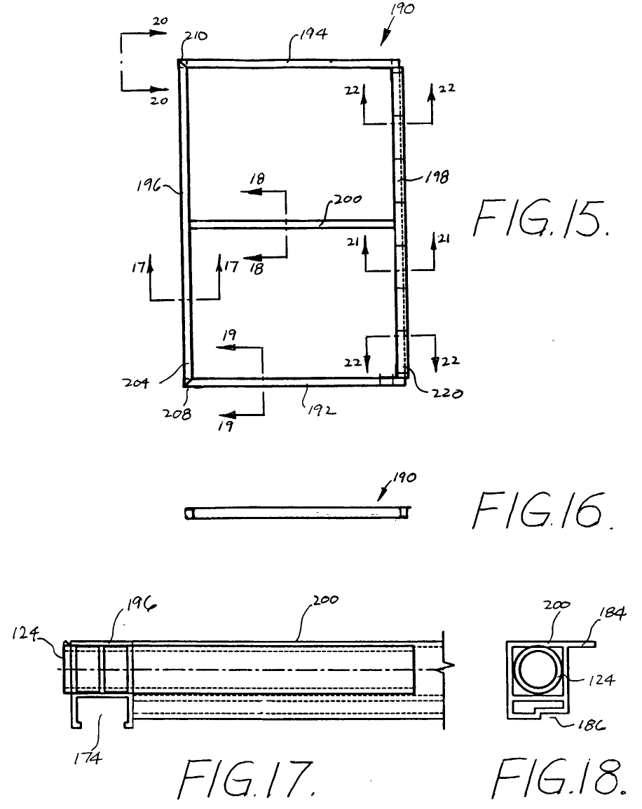

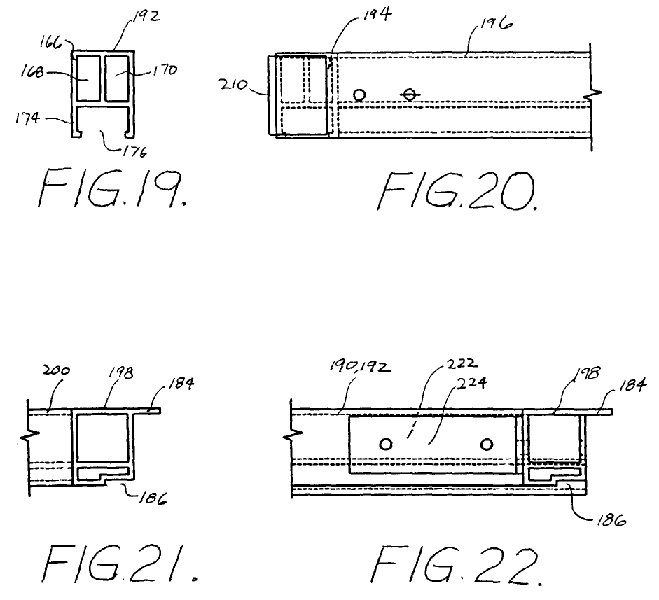

The two end pieces 150a, 150b are identical and may be interchangeable. Each end piece 150 has a frame 188 and a cover sheet 190 attached to the frame 188. FIGS. 15-22 illustrate the end frame 188. The end frame 188 is rectangularly shaped with three edge beams 192, 194, 196 forming the front, rear and outwardly side of the end frame. Each end frame 188 further includes an attachment beam 198 forming the inwardly side of the end frame and a support beam 200 connected to the attachment beam 198 and the side edge beam 196. The three edge beams 192, 194, 196 are cross-sectionally identical in shape and size. The attachment beam 198 and the support beam 200 are cross-sectionally identical in shape and size. As with the center frame 152, the use of beams which are cross-sectionally identical in shape and size for forming the end frame 188 reduces the complexity of the stock material. Furthermore, the edge beams 192, 194, 196 of the two end frames 188 and the edge beams 156, 158 of the center frame 152 are cross-sectionally identical in shape and size. The attachment beam 198 and the support beam 200 of the two end frames 188 and the attachment beams 160, 162 and the support beam 164 of the center frame 152 are also cross-sectionally identical in shape and size.

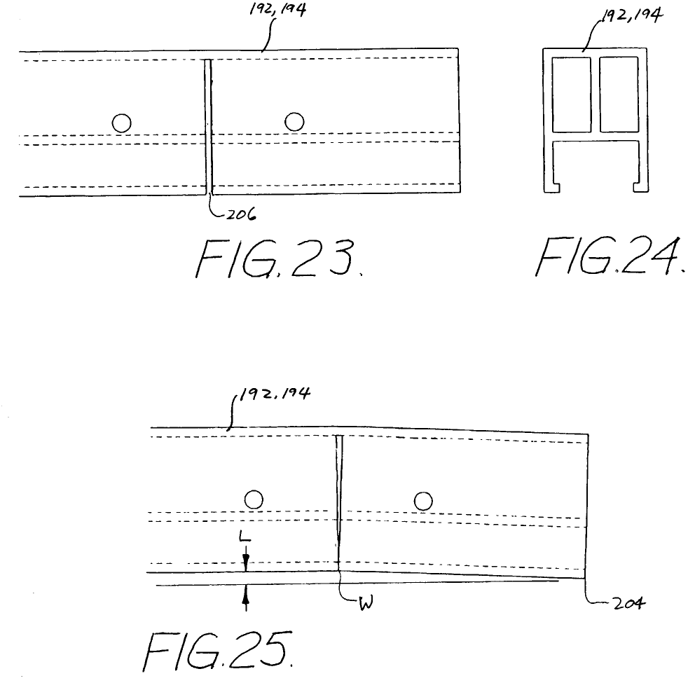

Due to the weight of the lid 116, the lid has a tendency to sag in the unsupported middle portion of the lid. Since the steps for opening and closing the lid 116 of the present invent requires the lid to slide along the top wall 112 of the container 110, a sagging lid may cause it to drag along the top wall 112 of the container or even abut the edge of opening 114 during closing, making opening and closing the lid extremely difficult. To prevent the lid 116 from dragging along top of the container, a feature of the lid 116 of the present invention is to bow the lid upwardly toward the unsupported middle portion of the lid to compensate for the sag that occurs due to the weight of the lid. The bow of the lid 116 is created by cambering each end piece 150, such that the attachment location 202 of the end piece is further away from the top wall 112 than the outwardly side 204 of each end piece. Since both end portions are cambered such the attachment location 202 is higher, the entire lid 116 is bowed upwardly toward the middle of the lid prior to the weight of the lid causing the unsupported middle portion to sag. As illustrated in FIGS. 23-25, the process for creating the cambered end pieces 150a, 150b is to cut the front and rear edge beams 192, 194 of each end frame 188 to remove a thin amount of material 206. The cut starts upwardly from the seal receptacle 174 and terminates before the uppermost wall of the box section 166. Thereafter, a fixture (not shown) is used to bend the two halves of each edge beam inwardly toward the removed material 206 until an one-half inch offset L, as illustrated in FIG. 24, is created. The bending of the edge beams creates the camber of the edge beams 192, 194. The two halves of each edge beam are welded together at point W to keep the camber at the angle necessary to create the one-half inch offset L. It should be noted that the amount of offset L is dependent on the weight of the lid an the rigidity of the lid. The one-half inch offset used for this embodiment is only an example of one particular lid design. Therefore, a lighter lid or a more rigid lid would require less offset and a heavier lid or a less rigid lid would require more offset.

The process for forming and assembling the lid 116 is to extrude a first stock material having an upper box section and a seal receptacle. A second stock having a tongue and a groove is extruded. The first stock is cut to the desired lengths to create the two edge beams 156, 158 of the center frame 152, the front edge beams 192 of the end frames 188, the rear edge beams 194 of the end frames 188 and the outwardly side beams 196 of the end frames 188. The second stock is cut to the desired lengths to create the two attachment beams 160, 162 and the support beam 164 of the center frame 152 and the attachment beams 198 and support beams 200 of the end frames 188.

The two edge beams 156, 158, the two attachment beams 160, 162 and the support beam 164 of the center frame are joined together to form the center frame 152. The center frame 152 is joined with the edge beams 156, 158 oriented with the seal receptacle 174 at the bottom; the attachments beams 160, 162 oriented with the tongue 184 at the bottom and the groove 186 at the top; and the support beam 164 oriented with the tongue 184 at the top.

One of the front edge beam 192, one of the rear edge beam 194, one of the outwardly side beam 196, one of the attachment beam 198 and one of the support beam 200 of the end frame are joined to together to form one of the end frame 188. Each end frame 188 is joined with the edge beams 192, 194, 196 oriented with the seal receptacle 174 at the bottom; the attachment beam 198 oriented with the tongue 184 at the top and the groove 186 at the bottom; and the support beam 200 oriented with the tongue 184 at the top.

A tubular pivot socket 124 extends through the side edge beam 196 of the end frame 188 and has an elongated portion 125 extending perpendicular from the inner surface of the side edge beam 196. The elongated portion 125 of the pivot socket 124 is inserted into the support beam 200. The outwardly end of the pivot socket 124 is exposed to receive the pivot rod of a carriage assembly 126 as illustrated in FIG. 4.

A L-shaped front reinforcement bracket 208, as illustrated in FIG. 15, is welded to the junction of the front edge beam 192 and the side edge beam 196 of the end frame 188. A L-shaped rear reinforcement bracket 210 is welded to the junction of the rear edge beam 194 and the side edge beam 196 of the end frame 188. The front and rear reinforcement brackets 208, 210 provide additional reinforcement for preventing the front and rear edge beams 192, 194 from separating from the side edge beam 196.

The center cover sheet 154 is attached to the top of the edge beams 156, 158 and the attachment beams 160, 162 of the center frame 152 through the use of double sided adhesive tape located between the beams 156, 158, 160, 162 and the center cover sheet 154. The double sided adhesive tape can be a commercially available pre-manufactured double sided adhesive tape or any other double sided adhesive tape that can be easily unrolled for applying onto a surface. The double sided adhesive tape should be of sufficient strength to bond the cover sheet to the frame. The double sided adhesive tape should also be water resistant and capable of keeping its adhesive property in the hot and cold environment that can expected in the location where the lid will be situated. The use of such double sided adhesive tape eliminates the need to use fasteners, such as rivets or bolts and nuts, to attach the cover sheet to the frame. The use of double sided adhesive tape also does not require the need to apply adhesive resin directly onto the frame or the cover sheet, which may be a very messy and labor intensive process. Rather, the double sided adhesive tape can be simply unrolled onto the top of the edge beams 156, 158 and the attachment beams 160, 162 of the center frame 152. The center cover sheet 154 covers the entire opening defined by the edge beams 156, 158 and the attachment beams 160, 162. The end cover sheet 190 is attached to the top of the edges beams 192, 194, 196 and the attachment beam 198 of each of the end frame 188 through the use of double sided adhesive tape located between the beams 192, 194, 196 and 198 and the end cover sheet 190. The end cover sheet 190 covers the entire opening defined by the edge beams 192, 194, 196 and the attachment beam 198.

To assemble the end pieces 150a, 150b with the center piece 148, one end of a rectangular alignment pin 212 is inserted into each outer rectangular cavity 168 of the front and rear edge beams 192, 194 of the end frame 188. The other end of the rectangular pin 212 is inserted into the corresponding outer rectangular cavity 168 of the front and rear edge beam 158, 160 of the center frame 152. The rectangular alignment pins 212 align the end pieces 150a, 150b with the center piece 148. Each end piece 150 is brought together with the center piece 148 until the tongue 184 at the top of each end piece 150 is inserted into the corresponding groove 182 at the top of the center piece 148. At the same time, the tongue 184 at the bottom of the center piece 148 is inserted into the groove 184 of the corresponding end piece 150. Thereafter, eight bolts 214 are inserted through corresponding holes 216 defined in the attachment beam 198 of the end piece 150 and the holes 218 defined in the attachment beam 160, 162 of the center piece 148 to secure each end piece 150 to the center piece 148.

Two handles 146 are attached to the front surface of the front edge beam 156 and two handles 146 are attached to the rear surface of the rear edge beam 158 of the center frame 152. The handles allow a person to grasp and pull the lid along the top wall 112 of the container 110 to open or close the lid 116. In addition to the rollers of the carriage assembly 126, two rollers 220 are attached to the outwardly side surface of each end frame 188. In conjunction with the rollers of the carriage assembly 126, the rollers 220 allow the lid 116 to roll along a set of guide rails 134 situated on the container 110.

Four ring brackets 143 are attached to the perimeter of the lid 116. Each ring bracket 143 is attached to the front or rear surface of one of the end pieces 150. The ring bracket 143 has a ring 144 to receive the hook of a corresponding locking clamp 138. Since the ring bracket 143 may experience a large pull out force once it is latched with the locking clamp 138, an outer backing plate 222 and an inner backing plate 224, as illustrated in FIG. 22, are located at both sides of the corresponding edge beams 192, 194 inwardly of each ring bracket 143 to provide extra support for the ring bracket 143 to prevent it from separating from the lid 116. Two bolts are inserted in corresponding holes defined in the ring bracket 143, the outer backing plate 222, the edge beam 192, 194 and the inner backing plate 224 to retain the ring bracket 143 to the lid 116.

Various features of the present invention have been described with reference to the above embodiments. It should be understood that modification may be made without departing from the spirit and scope of the invention as represented by the following claims.

1. A lid for a container comprising a center piece and two identically shaped and sized end pieces separably attached to opposite sides of said center piece.

2. The lid as claimed in claim 1 further comprising a gasket adapted to engage top of said container.

3. The lid as claimed in claim 1 wherein said center piece includes a frame and a cover sheet attached to said frame.

4. The lid as claimed in claim 3 wherein said center piece further includes a double sided adhesive tape situated between said cover sheet and said frame.

5. The lid as claimed in claim 1 wherein each said end piece includes a frame and a cover sheet attached to said frame.

6. The lid as claimed in claim 5 wherein each said end piece further includes a double sided adhesive tape situated between said cover sheet and said frame.

7. The lid as claimed in claim 1 further comprising a handle attached to said center piece.

8. The lid as claimed in claim 1 further comprising a roller attached to each of said end piece.

9. The lid as claimed in claim 1 wherein said center piece has two attachment beams and each said end piece has an attachment beams, each said attachment beam of said center piece has a tongue and a groove, said attachment beam of said end piece has a tongue and a groove, said tongue of each attachment beam of said center piece is inserted into said groove of said attachment beam of a corresponding end piece, said tongue of said attachment of said end piece is inserted into said groove of a corresponding attachment beam of said center piece.

10. The lid as claimed in claim 9 wherein said attachment beams of said center portion are cross-sectionally identical in shape and size.

11. The lid as claimed in claim 10 wherein said attachment beams of said center piece and said attachment beams of said end portions are cross-sectionally identical in shape and size.

12. The lid as claimed in claim 11 wherein each of said end piece is cambered such that the attachment location with said center piece is higher than the other side of said end piece.

13. A lid for a container comprising at least two pieces separably attached to each other.

14. The lid as claimed in claim 13 further comprising a gasket adapted to engage top of said container.

15. The lid as claimed in claim 13 wherein each of said piece includes a frame and a cover sheet attached to said frame.

16. The lid as claimed in claim 15 wherein each of said piece further includes a double sided adhesive tape situated between said cover sheet and said frame.

17. The lid as claimed in claim 13 further comprising a handle attached to one of said pieces.

18. The lid as claimed in claim 13 further comprising a roller attached to one of said pieces.

19. The lid as claimed in claim 13 wherein each said piece has a attachment beam, each said attachment beam has a tongue and a groove, said tongue of one of said attachment beam is inserted into said groove of another of said attachment beam and said tongue of said another of said attachment beam is inserted into said groove of said one of said attachment beam.

20. The lid as claimed in claim 19 wherein said attachment beams are cross-sectionally identical in shape and size.

21. A lid for a container comprising a frame, a cover sheet and a double sided adhesive tape situated between said cover sheet and said frame for attaching said cover sheet to said frame.
